(19) United States
(12) Patent Application Publication
(10) Pub. No.: US 2007/0012804 A1
(43) Pub. Date: Jan. 18, 2007

(54) Hand-held sprayer for hose rollers

(75) Inventor: Hermann Rabe, Landsberg (DE)

Correspondence Address: MARSHALL, GERSTEIN & BORUN LLP, 233 S. WACKER DRIVE, SUITE 6300, SEARS TOWER, CHICAGO, IL, 60606, US

(73) Assignee: RATIONAL AG, LANDSBERG/LECH (DE)

(21) Appl. No.: 10/544,730

(22) PCT Filed: Jan. 7, 2004
(86) PCT No.: PCT/DE04/00004

§ 371 Date: Aug. 23, 2006

(30) Foreign Application Priority Data
Feb. 6, 2003 (DE) 20301844.3

(51) Int. Cl. B05B 9/01; B65H 75/00

(52) U.S. Cl. 239/525; 239/195

(57) ABSTRACT

A hand-held sprayer includes an at least partially hollow shaft section, a liquid dispensing section and a hollow connecting plug element for connecting a hose extension to the hand-held sprayer. The connecting plug element is arranged within shaft section and can be fastened by a fastening element plugable through at least one opening from the outside into the shaft section and the connecting plug element has a groove running circumferentially around its outer periphery which the fastening element engages when the connecting plug element is fastened to the shaft section.

### RELATED APPLICATIONS

This is the U.S. national phase of International Application No. PCT/DE2004/000004 filed Jan. 7, 2004, the entire disclosure of which is incorporated herein by reference and claims priority to German application number 203 01 844.3 filed Feb. 6, 2003.

### TECHNICAL FIELD

The present invention concerns a hand-held sprayer with an at least partially hollow shaft section, a liquid dispensing section and a hollow connection plug element for connecting a hose extension to the hand-held sprayer, which is arranged within the shaft section and can be fastened by a fastening element plugable through at least one opening from the outside into the shaft section, in which the connecting plug element has a first mounting extension for connecting the hose extension with the connecting plug element and a second mounting extension for connecting the connecting plug element with the shaft section.

### BACKGROUND ART

Numerous hand-held sprayers are known from the prior art. These hand-held sprayers are used to divide the liquid jet supplied via a liquid conduit or liquid hose, especially a water jet, and distribute it via a sprayer or nozzle.

Such hand-held sprayers are used especially in the sanitary field, and there especially in showers.

However, hand-held sprayers are often used in large canteen kitchens and are arranged on or in cooking appliances in order to clean the cooking appliance with such hand-held sprayers. For example, cooking spaces within a cooking appliance can be sprayed and cleaned easily by these flexible hand-held sprayers using water and/or cleaning agents.

A generic hand-held sprayer is known from DE 3324383 A1, which discloses a device for fastening a hose to the handle of a hand-held sprayer, with a rigid tube nipple, which is provided with a sealing ring and fastened on the end of the hose with a squeeze clamp, a connection socket fastened to the handle of the hand-held sprayer with a hole passing through it, which from the inside out, forms a first position to the sealing ring, a second position for the squeeze clamp, a laterally opened third position for a fastening bolt and an opening for introduction of the hose, and a fastening bolt, which can be inserted into the third position so that it encloses the hose and to cooperate with the third position to prevent detachment of the squeeze clamp from the second position of the connection socket.

A hand-held sprayer is known from EP 0 927 580 B1 having a liquid feeding section and a liquid dispensing section. An outside threaded connection section is provided on the lower end of the liquid feeding section. This outside thread is used for coupling the connection section to a corresponding swivel nut of a liquid hose extension.

A straight through valve for spraying is known from DE 804 620 arranged in the handle of a spray tube. The handle is provided on the lower end with a nipple that ensures the connection of the feeding line of the spray liquid into the handle. Here again the feed line of the spray liquid is connected to the handle via a screw thread.

A distributor block is known from FR 1468174 in which several tube connections can be inserted. The tube connections are inserted in holes of the distributor block, secured with a seal and fastened to the distributor block with a clip. The tube connection has a groove into which the clip can engage to hold the tube connection.

U.S. Pat. No. 6,290,263 B1 discloses a detachable hose coupling in which two hose ends can be connected to each other by a sleeve. Fastening of the hose ends by the sleeves is accomplished by a U-shaped clamp that can be inserted from the outside into the holes of the sleeve.

Finally, a tube connector containing a rigid sleeve where tube ends can be inserted in is known from GB 902447 A. The sleeve has slit-like recesses that can be inserted into a U-shaped elastic clip in order to join the tube ends to the sleeve.

A drawback in the hand-held sprayers known from the prior art, however, is that an additional space is required in addition to the actual hand-held sprayer in order to provide an additional connector or thread on the lower end of the handle or shaft section, via which the feed hose can be attached. Sealing between the hose extension and handle via such a connector or thread is also often insufficient, especially when the threaded connection is loosened by the variety of rotational movements of the hand-held sprayer and this loosening leads to leakage. Fully free rotational movement of the hand-held sprayer independently of the movement of the feed hose is not guaranteed, i.e., if the hand-held sprayer is rotated 360°, the screw-on feed hose is also rotated accordingly because of the rigid connection.

### SUMMARY

It is therefore the task of the present disclosure to further modify the generic hand-held sprayer so that the drawbacks of the prior art are overcome, in particular, a smaller space requirement for connection of the hose to the hand-held sprayer is required and free movement of the hand-held sprayer independently of the movement of the hose is possible.

The task is solved in that the connecting plug element has a groove running circumferentially around its outer periphery in which the fastening element engages when the connecting plug element is fastened to the shaft section and the second mounting extension has essentially the shape of a hollow tube that can be mounted to a third mounting extension in the shaft section formed in one piece with the shaft section.

The first mounting extension is preferably a tube extension having a reduced diameter relative to the connecting plug element and being mountable to the hose extension.

The hand-held sprayer is preferably characterized by at least one seal between the hose extension and the first mounting extension and/or between the second mounting extension and the third mounting extension.

It is also prescribed that each seal is a radially acting O-ring.

With particular preference, the hose extension is securely fastened to the connecting plug element by a securing element, like a hose clamp.

The fastening element also preferably then assumes an essentially U-shape with two arms of the U-shape engaging in the groove of the connecting plug element on opposite sides.

It is then preferably prescribed that the fastening element be a spring steel insert.

With particular preference, the hand-held sprayer is arranged on or in a cooking appliance.

The disclosed hand-held sprayer is therefore based on the surprising finding that because of the special plug system of the hand-held sprayer, in the first place, a situation is achieved in which a limited space is required for connection of a hose to a hand-held sprayer, since the space required for gripping of the hand-held sprayer for this connection, namely the shaft section, is used. In the second place, it is possible with the disclosed hand-held sprayer to achieve torque-independent sealing of the connection of the hand-held sprayer and hose, especially by radially acting O-rings between the corresponding mounting extensions.

Finally, it is emphasized that because of the special plug connection between the hand-held sprayer and the hose, rotation of the hand-held sprayer by 360° around the hose is possible, and this rotation is not interfered with by any fastening elements and does not adversely affect sealing of this connection. If the disclosed hand-held sprayer is rotated, the connected hose does not rotate with it.

### BRIEF DESCRIPTION OF THE DRAWINGS

Additional features and advantages of the invention are apparent from the following detailed description of a preferred embodiment of the hand-held sprayer by means of schematic drawings in which:

FIG. 1 shows a partial longitudinal section through a preferred embodiment of the hand-held sprayer;

FIG. 2 shows an exploded view of the hand-held sprayer according to FIG. 1; and

FIG. 3 shows the fully-assembled hand-held sprayer according to FIGS. 1 and 2.

### DETAILED DESCRIPTION

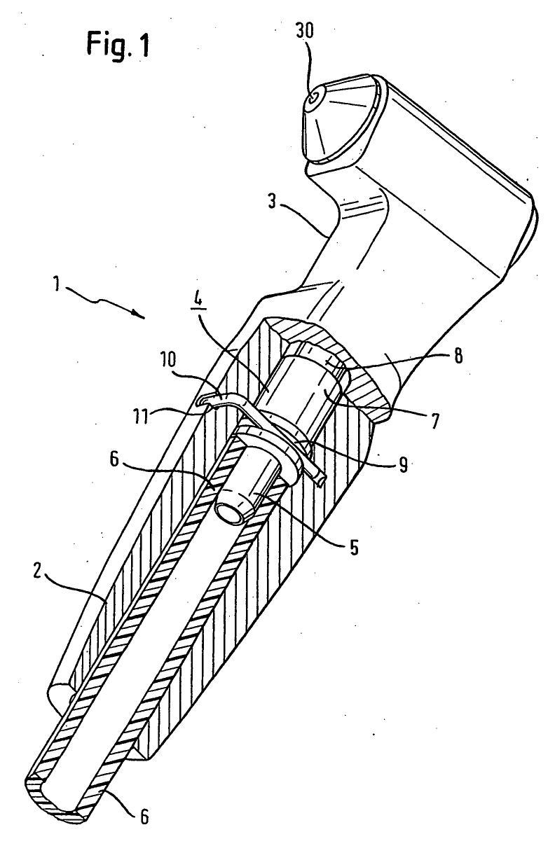

FIG. 1 shows a partial longitudinal section of a hand-held sprayer 1, having a shaft section 2 and a liquid dispensing section 30 that discharges in a spray head 30.

The shaft section 2 is designed at least partially hollow in order to accommodate the plug-in components. A connecting plug element 4 is arranged within shaft section 2. The connecting plug element 4 has a first mounting extension 5 for mounting of a hose extension 6 on connecting plug element 4 and a second mounting extension 7 for connection of the connecting plug element 4 to hand-held sprayer 1. In the preferred embodiment depicted in FIG. 1 of a hand-held sprayer 1, the first mounting extension 5 is a tube extension whose diameter is reduced relative to the diameter of the connecting plug element 4 so that the hose extension 6 can be mounted on this tube extension. The diameter of the tube extension essentially corresponds to the inside diameter of the respective, connectable hose. The hose extension 6 can also be securely fastened to the first mounting extension 5 by hose clamps (not shown).

The second mounting extension 7 is preferably shaped in the form of a hollow tube that can be mounted on a corresponding third mounting extension 8 of hand-held sprayer 1. The mounting extension 8 of hand-held sprayer 1 can assume the form of a connector, for example.

Seals (not shown) are preferably provided between the hose extension 6 and the first mounting extension 5, as well as between the second mounting extension 7 and the third mounting extension 8, which prevent liquid supplied via the hose, especially water, from emerging at the corresponding plug connection sites.

The connecting plug element 4 also has a groove 9 running circumferentially on its outer periphery.

If the hose extension 6 is mounted on the connecting plug element 4 and the connecting plug element 4 is connected to hand-held sprayer 1, the connecting plug element 4 can be securely fastened to hand-held sprayer 1 by a fastening element 10. This fastening element 10, which can be introduced through at least one opening 11 of shaft section 2 from the outside into the interior of shaft section 2, engages in the groove 9 of the connecting plug element 4 and secures it so that movement or sliding of the connecting plug element 4 within the shaft section 2 is essentially completely avoided. It is then important that the opening 11 and the groove 9 be arranged so that the fastening element 10 can engage directly in groove 9 when inserted through opening 11.

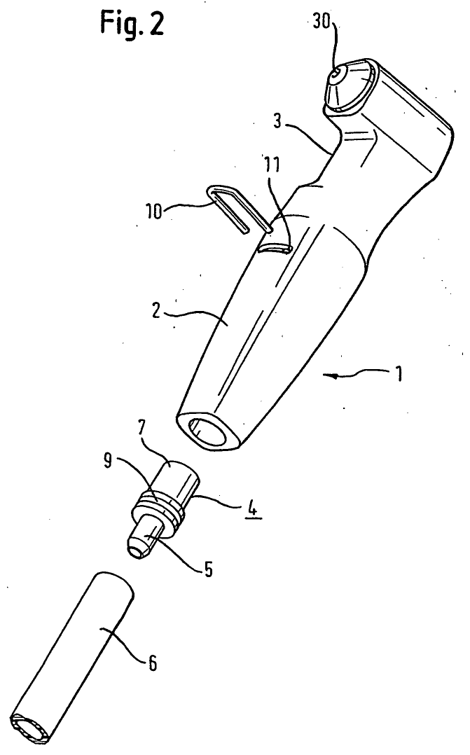

As shown in particular in FIG. 2, the fastening element 10 is preferably in a U-shape so that both arms of the U-shape can engage through corresponding opening 11 in groove 9 of connecting plug element 4 on opposite sides.

The hose extension 6 can be separated again simply from the hand-held sprayer 1 by removing the fastening element 10 from opening 11 so that the fastening element 10 is disengaged from groove 9. The hose extension can then be withdrawn easily from the hand-held sprayer with the connecting plug element 4.

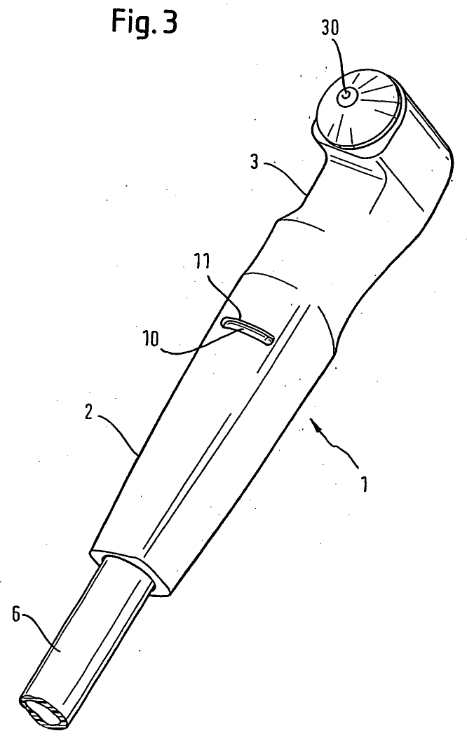

FIG. 3 shows the hand-held sprayer 1 in the fully assembled form. As it is also apparent from FIG. 3, the hand-held sprayer 1 does not require screw threading for attachment of the hose extension to the hand-held sprayer. On the one hand, this reduces the required space, and on the other hand ensures torque-independent sealing of the connection between the hose and the hand-held sprayer as well as free movement of the hand-held sprayer independently of the connected hose.

The hand-held sprayer described herein can be used, for example, in showers or also in cooking appliances in order to clean cooking appliances with water and/or cleaning agents.

The features of the invention disclosed in the preceding description, in the claims and in the drawings can be essential both individually and in any combination for the implementation of the invention in its different variants.

### LIST OF REFERENCE NUMBERS

1 Hand-held sprayer

2 Shaft section

30 Sprayhead

3 Liquid dispensing section

4 Connecting plug element

5 Mounting extension

6 Hose extension

7 Mounting extension

8 Mounting extension

9 Groove

10 Fastening element

11 Opening

1. Hand-held sprayer (1) with an at least partially hollow shaft section (2), a liquid dispensing section (3), and a hollow connecting plug element (4) for connecting a hose extension (6) to the hand-held sprayer (1), which is arranged within shaft section (2) and can be fastened by a fastening element (10) plugable through at least one opening (11) from the outside into the shaft section (2), characterized by the fact that the connecting plug element (4) has a groove (9) running circumferentially around its outer periphery in which the fastening element (10) engages when the connecting plug element (4) is fastened to the shaft section (2).

2. Hand-held sprayer according to claim 1, characterized by the fact that the connecting plug element (4) has a first mounting extension (5) for connecting the hose extension (6) with the connecting plug element (4) and a second mounting extension (7) for connecting the connecting plug element (4) with the shaft section (2).

3. Hand-held sprayer according to claim 2, characterized by the fact that the first mounting extension is a tube extension (5) that has a reduced diameter relative to the connecting plug element (4) and being mountable to the hose extension (6).

4. Hand-held sprayer according to claim 2 or 3, characterized by the fact that the second mounting extension (7) has essentially the shape of a hollow tube that can be mounted to a third mounting extension (8) in shaft section (2), preferably formed in one piece with the shaft section (2).

5. Hand-held sprayer according to one of claims 2 to 4, characterized by at least one seal between the hose extension (6) and the first mounting extension (5) and/or between the second mounting extension (7) and the third mounting extension (8).

6. Hand-held sprayer according to claim 5, characterized by the fact that each seal is a radially-acting O-ring.

7. Hand-held sprayer according to one of the preceding claims, characterized by the fact that the hose extension (6) is securely fastened to the connecting plug element (4) by a securing element, like a hose clamp.

8. Hand-held sprayer according to one of the preceding claims, characterized by the fact that the fastening element (10) assumes essentially a U-shape with two arms of the U-shape engaging in the groove (9) of the connecting plug element (4) on opposite sides.

9. Hand-held sprayer according to one of the preceding claims, characterized by the fact that fastening element (10) is a spring steel insert.

10. Hand-held sprayer according to one of the preceding claims arranged on or in a cooking appliance.
